(19) United States
(12) Patent Application Publication
(10) Pub. No.: US 2015/0280768 A1
(43) Pub. Date: Oct. 1, 2015

(54) PROTECTIVE COVER FOR A TABLET

(71) Applicant: Dean Shoes Company Ltd., Taichung City (TW)

(72) Inventor: Chen-Yuan Huang, Taichung City (TW)

(73) Assignee: Dean Shoes Company Ltd., Taichung City (TW)

(21) Appl. No.: 14/231,734

(22) Filed: Mar. 31, 2014

(51) Int. Cl. H04B 1/3888; H04B 1/3877; H04M 1/725; A45C 11/00

(52) U.S. Cl. CPC H04B 1/3888; A45C 11/00; H04B 1/3877; H04M 1/7253; A45C 2011/003

(57) ABSTRACT

A protective cover for a tablet includes a foldable board, a base board, a wireless communication module, and a first input device. A foldable board comprising a first segment, and a second segment connected to the one side of the first segment and foldable with respect to the first segment, and the foldable board defining limiting members on edges of the interior surface of the foldable board; a base board connected to an opposite side of the first segment and foldable with respect to the first segment; a first input device mounted on the base board to be connected to the tablet by means of the wireless communication module; wherein the first segment and the second segment are foldable with respective to each other to form a triangular support structure supported by the holder lobe.

### BACKGROUND OF THE INVENTION

1. Field of the Invention

This invention relates to an accessory for an electronic device, and more particularly a cover for protecting and supporting a tablet, which is equipped with an input device.

2. Description of the Related Art

Tablet computers, or simply tablets, are more and more popular in these days because it is portable and entertaining. In particular, a variety of tablet covers have been devised for protecting tablets.

A conventional tablet cover comprises a top cover having a top cover hinge mounted on a side edge of the top cover; a bottom cover having a bottom cover hinge mounted on an outside surface of the bottom cover; and an extension arm swivel connected to the bottom cover at the bottom cover hinge. The length of the extension arm is approximately half of a width of the tablet cover. The intermediate hinge arm is swivel connected to the extension arm at an intermediate hinge and the intermediate hinge arm is swivel connected to the top cover at the top cover hinge. A length of the intermediate hinge arm is approximately a thickness of the tablet cover. The tablet cover has an open position, a stand position and a closed position. However, when the conventional tablet cover is in the stand position, a tablet can only positioned in one side of the tablet cover, that is inconvenient to operate and view the tablet as the people sit opposite to each other.

Nowadays people use a visual keyboard to control the tablet in general. But using a visual keyboard is more inconvenient than using a real keyboard.

In view of the prior invention provided an inconvenience functions to people, and the disadvantages of using visual keyboard. The present invention has arisen to mitigate and/or obviate the disadvantages of the conventional tablet cover.

### SUMMARY OF THE INVENTION

The main objective, of the present invention is to provide an improved tablet cover.

To achieve the objective, a protective cover for a tablet, comprising: a foldable board having an interior surface, an exterior surface, and comprising a first segment, and a second segment connected to the one side of the first segment and foldable with respect to the first segment, and the foldable board defining a plurality of limiting members on edges of the interior surface of the foldable board for positioning the tablet;

a base board connected to an opposite side of the first segment and foldable with respect to the first segment, and the base board having an interior surface, an exterior surface, wherein when the protective cover in a closed configuration, the interior surface of the base board faces the interior surface of the foldable board, and the exterior surface of the base board defining a holder lobe thereon; a wireless communication module disposed in the base board; a first input device mounted on the base board and adjacent to the holder lobe to be connected to the tablet by means of the wireless communication module; wherein the first segment and the second segment are foldable with respective to each other to form a triangular support structure supported by the holder lobe.

Specifically, the base board has a second input device to be connected to the tablet by means of the wireless communication module, and the wireless communication module is a Bluetooth module. The base board has a second input device to be connected to the tablet by means of the wireless communication module, and the wireless communication module is a Wi-Fi module. The second input device is a touch pad. The base board has a storage space therein for accommodating the second input device. The second input device connected to the base cover, and attached to the interior surface of the base board by folding with respect with the base cover. The second input device connected to the base board and has a first connective member thereon, the base board has a second connective member thereon for connecting to the first connective member. The second segment has a first magnetic element embedded therein, and the holder lobe 31 has a second magnetic element therein to be coupled to the first magnetic element of the second segment. The first segment has a non-skid layer thereon.

Further comprising a power switch and a rechargeable battery are disposed in the base cover, the power switch coupled to the rechargeable battery and the first input device. Further comprising a plurality of connection ports and a data access module, the connection ports are coupled to the rechargeable battery and the data access module.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a protective cover of the present invention in a closed state in accordance with a preferred embodiment of the present invention;

FIG. 2 is a perspective view of a protective cover of the present invention in a open state;

FIG. 3 illustrates that the protective cover is folded to a stand position;

FIG. 4 illustrates that a tablet is positioned upright in one side of the foldable board of the protective cover of FIG. 3;

FIG. 5 illustrates that a tablet is positioned upright in opposite side of the foldable board of the protective cover of FIG. 3;

FIG. 6 illustrates that a tablet is positioned upright of the foldable board and the connection port coupled to the tablet by the cable;

FIG. 7 illustrates that the protective cover coupled to an mains electricity by the cable;

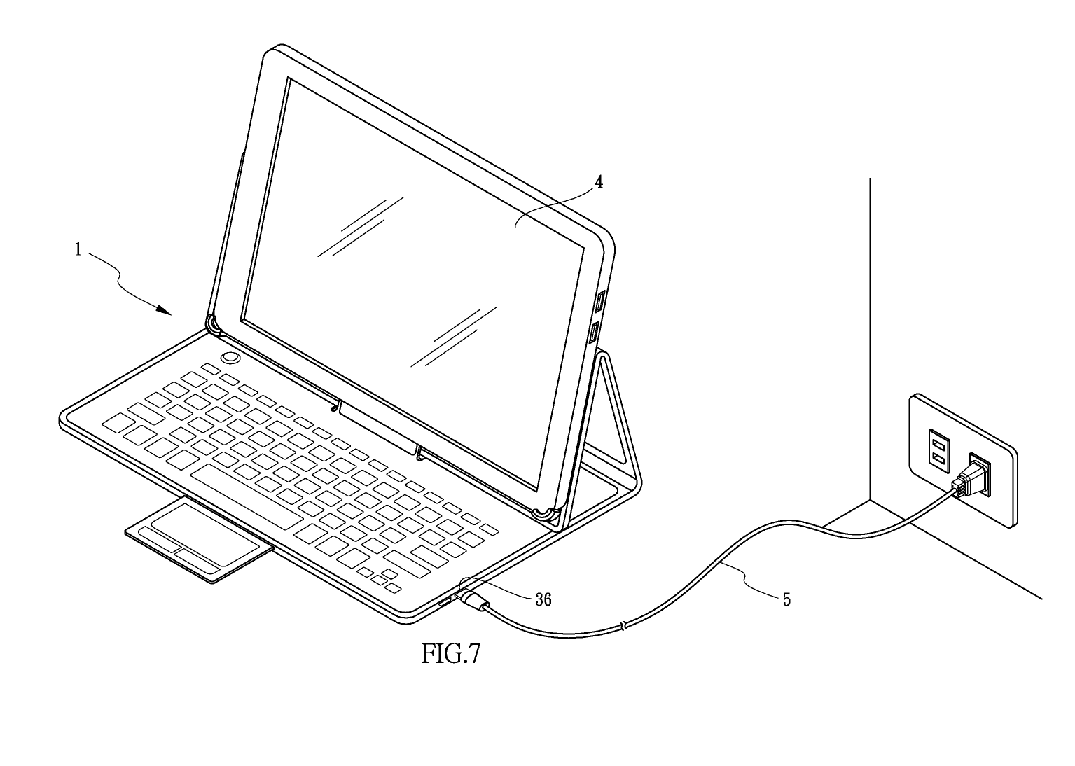

FIG. 8 illustrates that the protective cover coupled to a laptop by the cable;

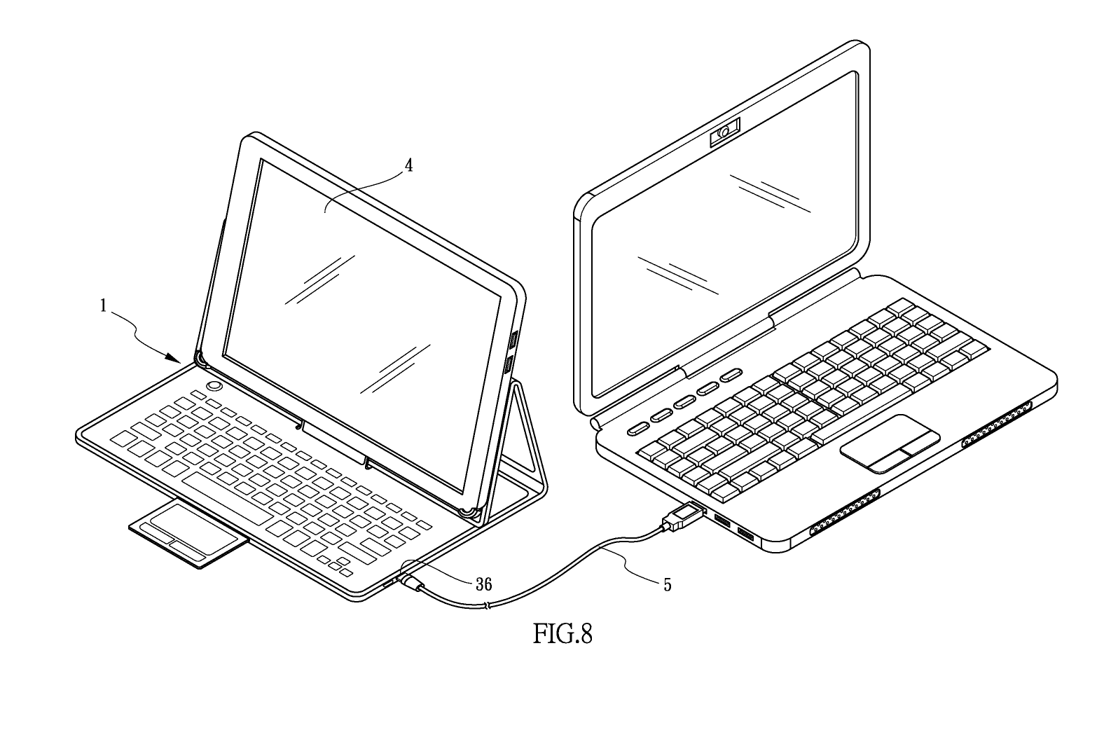

FIG. 9 illustrates that the first segment and the second segment of the foldable board define a non-skid layer thereon;

FIG. 10 illustrates that the second input device has a first connective member and the base board has a second connective member.

### DETAILED DESCRIPTION OF EMBODIMENTS

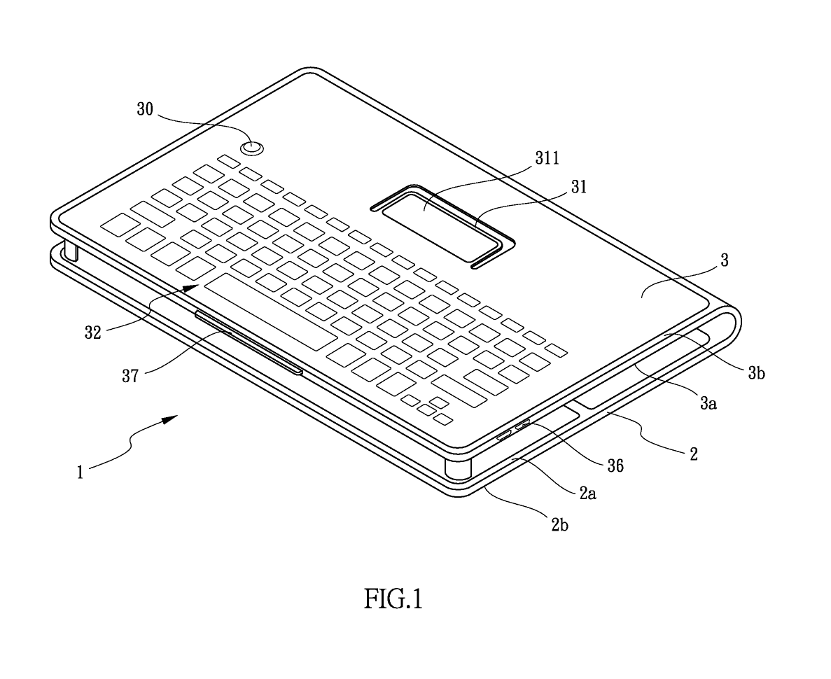

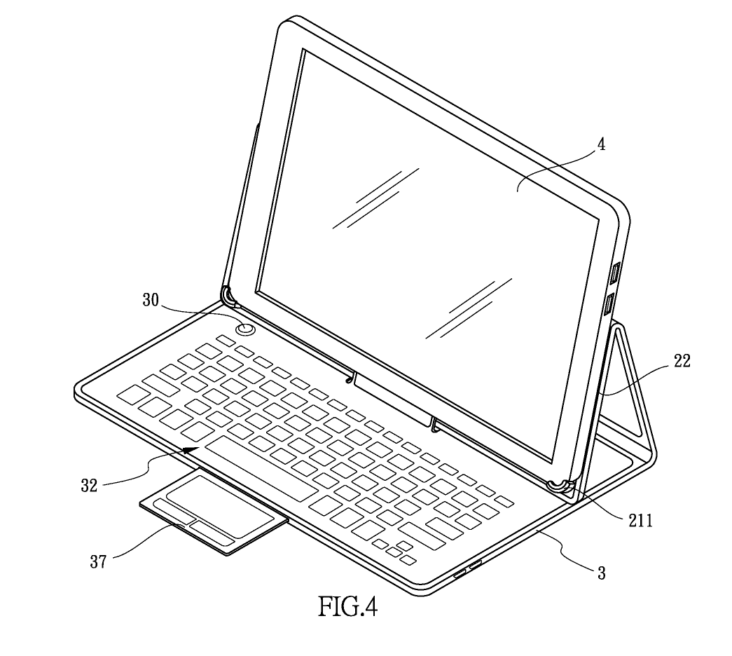

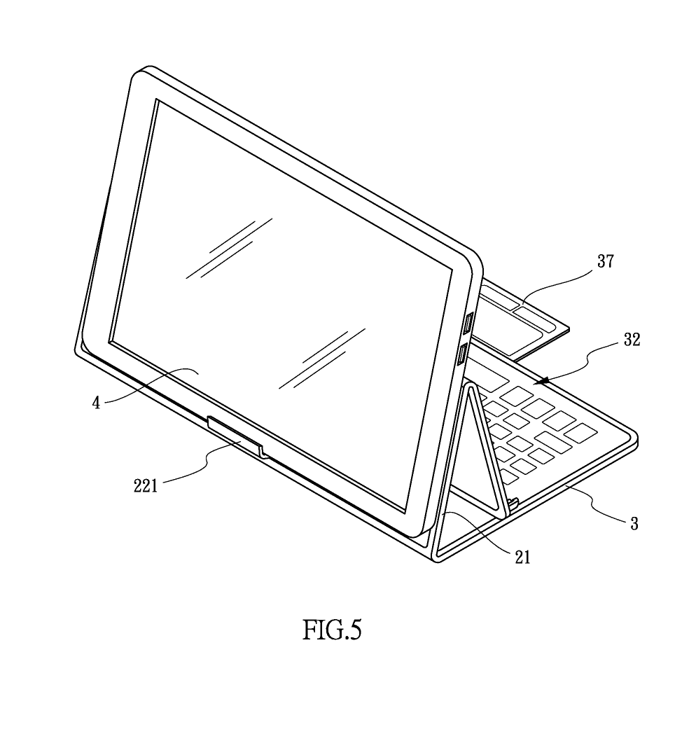

Referring to FIGS. 1-5, the protective cover in accordance with a preferred embodiment of the present invention, which is used for a tablet comprises a foldable board 2, a base board 3, a wireless communication module 34, and a first input device 32. The foldable board 2 comprising a first segment 21 and a second segment 22 connected to the one side of the first segment 21 and foldable with respect to the first segment 21. The foldable board 2 has an interior surface 2a, an exterior surface 2b, and defines a plurality of limiting members 211,221 on edges of the interior surface 2a of the foldable board 2 for positioning the tablet 4. A base board 3 is connected to an opposite side of the first segment 21 and foldable with respect to it, and the base board 3 has an interior surface 3a and an exterior surface 3b, wherein when the protective cover 1 in a closed state, the interior surface 3a of the base board 3 faces the interior surface 2a of the foldable board 2, and the exterior surface 3b of the base board 3 defines a holder lobe 31 thereon. A wireless communication module 34 is disposed in the base board 3. A first input device 32 is mounted on the base board 3 and adjacent to the holder lobe 31 to be connected to the tablet 4 by means of the wireless communication module 34 (the wireless communication 34 is a Bluetooth module or a Wi-Fi module), and the first input device 32 is a keyboard.

The first segment 21 and the second segment 22 are foldable with respective to each other to form a triangular support structure supported by the holder lobe 31. Thus, the tablet 4 can be selectively placed upright on the first segment 21 or second segment 22. Under this arrangement, the protective cover 1 of the present invention provides two directions for the users to place the tablet 4 at front side or backward side of the user depending on their needs (For instance, in order to face the touch panel of the tablet 4 from the operator to whom sits opposite on business situation). Besides, the first input device 32 provides for, user to input the texts to the tablet 4 by means of the wireless communication module 34.

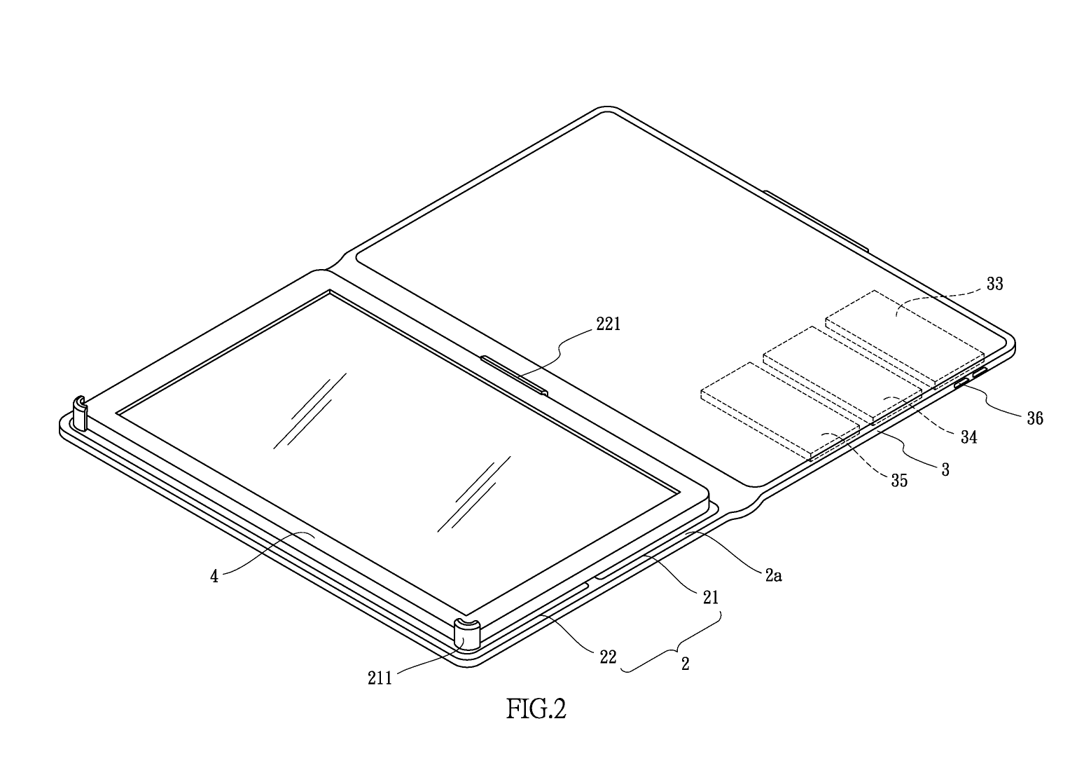

Referring to FIG. 2, the tablet 4 can be secured to the foldable board 2 by the limiting members 211, 212, and the base board 3 is turned relative to the foldable board 2 so that the protective cover 1 is in the closed configuration for protecting the tablet 4 (As shown in FIG. 1).

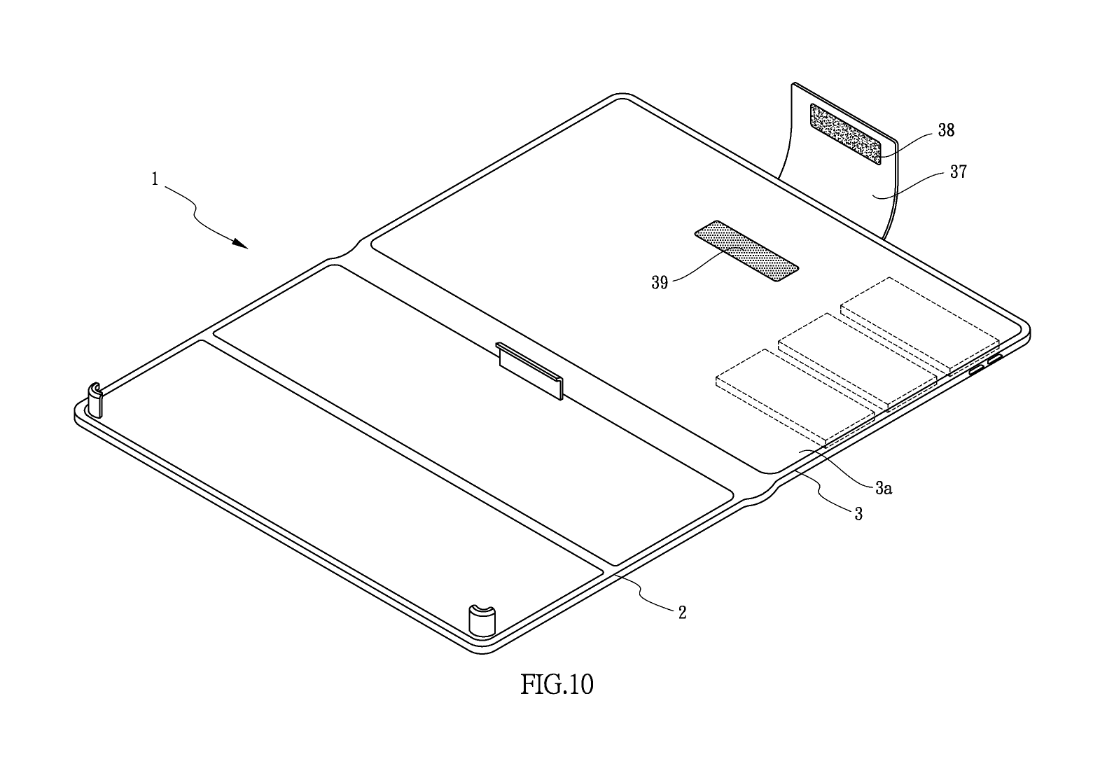

FIGS. 1-4 show, the base board 3 has a second input device 37 to be connected to the tablet 4 by means of the wireless communication module 34. In one embodiment, the base board 3 has a storage space therein for accommodating the second input device 22, hence the second input device 22 can be moving inside the storage space when not using it, and moving outside the storage space for using it. In the other embodiment shows in FIG. 10, the second input device 37 connected to the base board 3 and attached to the interior surface 31 of the base board 3 by folding with respect to the base board 3. Furthermore, the second input device 22 has a first connective member 38 thereon, the base board 3 has a second connective member 39 thereon for connecting to the first connective member 38. Therefore, the second input device 22 can be coupled or separated to the interior surface 31 of the base board 3 repeatedly through the first connective member 38 and second connective member 39.

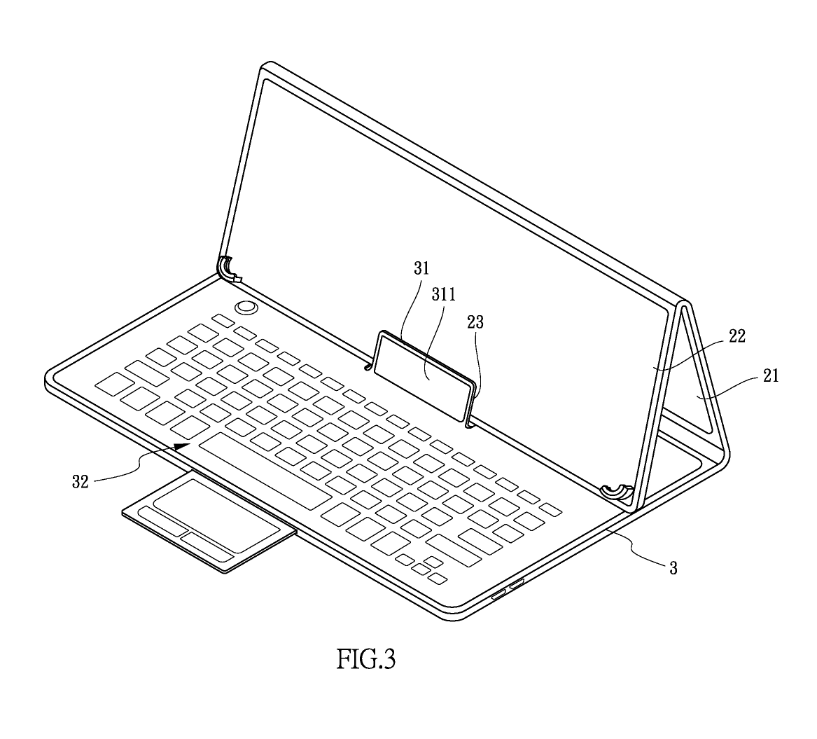

Referring to FIG. 3, the second segment 21 has a first magnetic element 23 embedded therein, and the holder lobe 31 has a second magnetic element 311 therein to be coupled to the first magnetic element of the second segment 21 so as to increase the strength function of positioning and supporting the tablet 4.

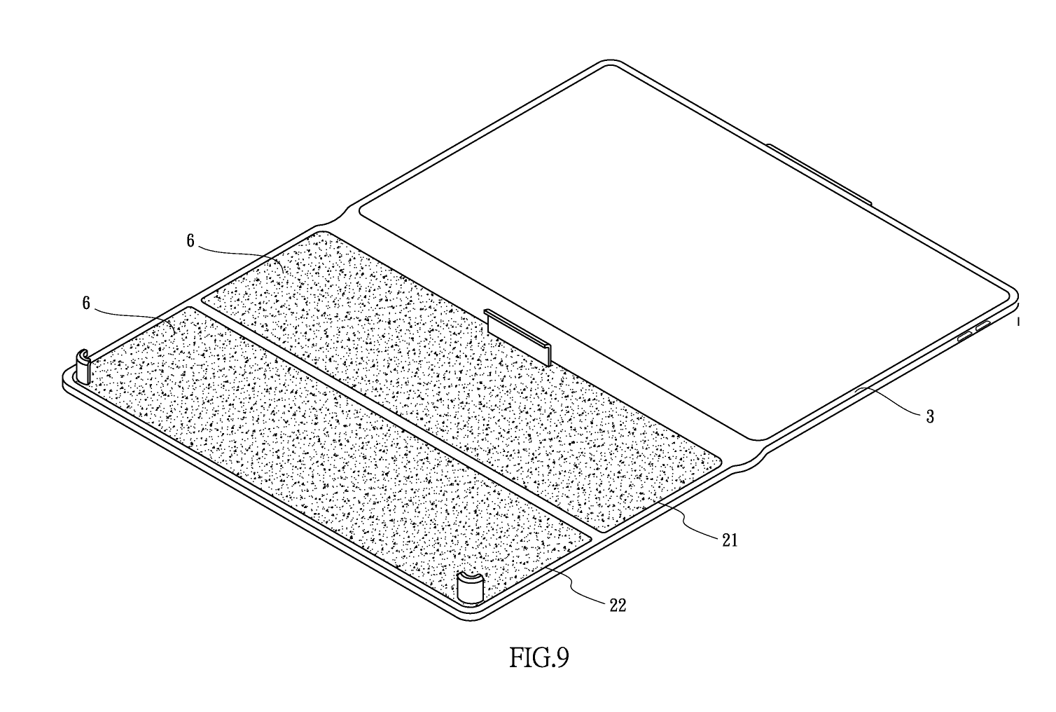

Referring to FIG. 9, the first segment 21 has a non-skid layer 6 thereon for positioning the tablet 4 on the non-skid layer 6 stability.

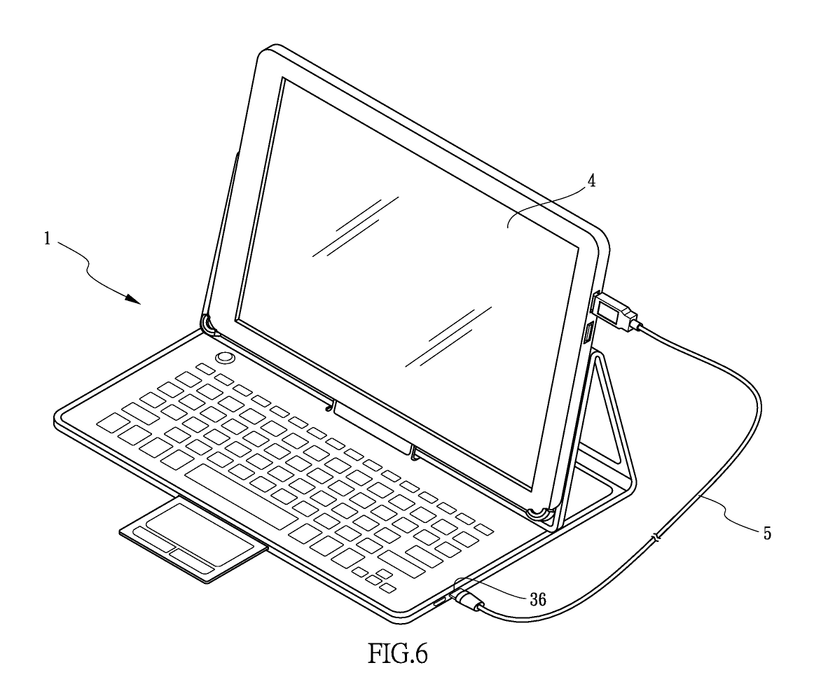

Referring to FIG. 2, further comprising a power switch 30 and a rechargeable battery 33 are disposed in the base board 3, the power switch 30 coupled to the rechargeable battery 33 and the first input device 32 for switch the power of rechargeable battery 33 on or off Moreover, further comprising a plurality of connection ports 36 and a data access module 35, the connection ports 36 are coupled to the rechargeable battery 33 and the data access module 35. As the described above, when the tablet 4 in a low battery state, the tablet 4 can be recharged through the rechargeable battery 33 by using the cable 5 to couple the tablet 4 to one of the connection port 36, as shown in FIG. 6. Besides, the rechargeable battery 33 can be recharged by using the cable 5 to couple the rechargeable battery 33 to the mains electricity. Furthermore, the connection port 36 which connected to the data access module 35 can be coupled to the other laptop (or tablet) by the cable 5 for transmitting data to each other.

It is to be understood that the disclosed embodiments are illustrative in nature and the invention is not to be limited to any one or more embodiments except as set forth in the following claims.

What is claimed is:

1. A protective cover for a tablet, comprising:
a foldable board comprising a first segment, and a second segment connected to the one side of the first segment and foldable with respect to the first segment, the foldable board having an interior surface, an exterior surface and defining a plurality of limiting members on edges of the interior surface of the foldable board for positioning the tablet;
a base board connected to an opposite side of the first segment and foldable with respect to the first segment, and the base board having an interior surface, an exterior surface, wherein when the protective cover in a closed configuration, the interior surface of the base board faces the interior surface of the foldable board, and the exterior surface of the base board defining a holder lobe thereon;
a wireless communication module disposed in the base board;
a first input device mounted on the base board and adjacent to the holder lobe to be connected to the tablet by means of the wireless communication module;
wherein the first segment and the second segment are foldable with respective to each other to form a triangular support structure supported by the holder lobe.

2. The protective cover of claim 1, wherein the base board has a second input device to be connected to the tablet by means of the wireless communication module, and the wireless communication module 34 is a Bluetooth module.

3. The protective cover of claim 1, wherein the base board 3 has a second input device to be connected to the tablet by means of the wireless communication module, and the wireless communication module is a Wi-Fi module.

4. The protective cover for a tablet of claim 2, wherein the second input device is a touch pad.

5. The protective cover for a tablet of claim 3, wherein the base board has a storage space therein for accommodating the second input device.

6. The protective cover for a tablet of claim 3, wherein the second input device connected to the base board, and attached to the interior surface of the base board by folding with respect to the base board.

7. The protective cover for a tablet of claim 5, wherein the second input device connected to the base board and has a first connective member thereon, the base board has a second connective member thereon for connecting to the first connective member.

8. The protective cover for a tablet of claim 1, wherein the second segment has a first magnetic element embedded therein, and the holder lobe has a second magnetic element therein to be coupled to the first magnetic element of the second segment.

9. The protective cover for a tablet of claim 1, wherein the first segment 21 has a non-skid layer thereon.

10. The protective cover for a tablet of claim 1 further comprising a power switch and a rechargeable battery are disposed in the base board, the power switch coupled to the rechargeable battery and the first input device. 11 The protective cover for a tablet of claim 1, further comprising a plurality of connection ports and a data access module, the connection ports are coupled to the rechargeable battery and the data access module.
